(19) United States
(12) Patent Application Publication
(10) Pub. No.: US 2026/0145914 A1
(43) Pub. Date: May 28, 2026

(54) A LIFTING APPARATUS AND A METHOD FOR LIFTING A LONGITUDINAL BENDABLE STRUCTURE SUCH AS A WIND TURBINE BLADE

(71) Applicant: ALVAC INDUSTRY A/S, Mejrup, Holstebro (DK)

(72) Inventor: Ole MOGENSEN, Holstebro (DK)

(21) Appl. No.: 19/121,578

(22) PCT Filed: Oct. 30, 2023
(86) PCT No.: PCT/DK2023/050255

§ 371 Date: Apr. 16, 2025

(30) Foreign Application Priority Data
Oct. 31, 2022 (DK) PA202270528

(51) Int. Cl. B66C 1/02; B66C 13/14; F03D 13/10

(52) U.S. Cl. CPC B66C 1/0243; B66C 1/0256; B66C 1/0281; B66C 13/14; F03D 13/104; F03D 13/139

(57) ABSTRACT

A lifting apparatus for lifting a longitudinal bendable structure such as a wind turbine blade is provided, the lifting apparatus includes—a longitudinal beam including one or more sections and one or more rigging elements; —a plurality of attachment units positioned along the longitudinal beam; the attachment units include—a vacuum gripper for gripping a part of a longitudinal structure; —a displaceable arm connected to the vacuum gripper, the displaceable arm being linear displaceable between a retracted position and an extended position; —a power transmission unit configured to displacing the displaceable arm between the retracted position and the extended position; —a global power transmission system in fluid communication with the power transmission units, the global power transmission system being configured for balancing the power transmission units.

### CROSS REFERENCE TO RELATED APPLICATIONS

This application is a national stage of PCT Application No. PCT/DK2023/050255, having a filing date of Oct. 30, 2023, which is based on DK Application No. PA 2022 70528, having a filing date of Oct. 31, 2022, the entire contents both of which are hereby incorporated by reference.

### FIELD OF TECHNOLOGY

The following relates to a lifting apparatus and a method for lifting a longitudinal bendable structure such as a wind turbine blade.

### BACKGROUND

Wind turbines are installed rapidly across the globe as part of the green transition, and during both production and installation of wind turbines there is a need for lifting the wind turbine blades. However, wind turbine blades are flexible with an increasing flexibility from the root end towards the tip end of the blade. This flexibility significantly complicates the lifting process and what is required of the lifting apparatus.

Present day lifting methods and apparatuses are configured for grabbing around the wind turbine blade at two positions: either at each end of the wind turbine blade or in the middle of the wind turbine blade. The problem with these lifting methods and apparatuses is that they cannot accommodate the flexing of the tip end of the wind turbine blade that occurs during a lift. This may result in excessive bending and flexing of the wind turbine blade, which might introduce damages to the wind turbine blade and in worst case result in the wind turbine blade being dropped.

Other present day methods and apparatus utilise a plurality of suction discs to attach the wind turbine blade to the lifting apparatus. The problem with these methods and apparatus is that they cannot accommodate the flexing of the tip end of the wind turbine blade that occurs during a lift. Thus, when the wind turbine blade flex or bend, it can tear itself free from one or more the suction discs, which can result in the wind turbine blade being dropped. Another disadvantage is that an oversized lifting apparatus is needed to manage the loss of attachment force that occurs when a suction disc loses its grip to avoid the wind turbine blade being dropped.

There is a need in the conventional art for a lifting apparatus and a method for lifting a wind turbine blade, that can accommodate the flexing and bending of the tip end of the wind turbine blade without losing the grip of the wind turbine blade. Thereby ensuring a controlled lift and minimizing the risk of damaging and dropping the wind turbine blade during the lifting process.

### SUMMARY

An aspect relates to a lifting apparatus and a method for lifting a longitudinal bendable structure such as a wind turbine blade, that can accommodate the flexing and bending of the longitudinal bendable structure without losing the grip of the longitudinal bendable structure. Thereby ensuring a controlled lift during the entire lifting process.

An aspect of embodiments of the invention is achieved by a lifting apparatus for lifting a longitudinal bendable structure such as a wind turbine blade. The lifting apparatus comprises
a longitudinal beam comprising one or more sections and one or more rigging elements;
a plurality of attachment units positioned along the longitudinal beam; the attachment units comprise
   a vacuum gripper for gripping a part of the longitudinal bendable structure;
   a displaceable arm connected to the vacuum gripper, the displaceable arm being linear displaceable between a retracted position and an extended position;
   a power transmission unit configured to displacing the displaceable arm between the retracted position and the extended position;
a global power transmission system in fluid communication with the power transmission units, the global power transmission system being configured for balancing the power transmission units.

The lifting apparatus is a lifting apparatus for lifting a longitudinal bendable structure such as a wind turbine blade, where a part of or the entire wind turbine blade may be lifted. The stiffer root end of the wind turbine blade is easy to grab compared to the more flexible tip end of the wind turbine blade. Thus, conventional art can lift the root end but not the tip end of the wind turbine blade. Embodiments of the present invention may lift the entire wind turbine blade, but typically a combination with conventional art would be utilized, where the conventional art lifts the root end, and embodiments of the present invention lifts the tip end of the wind turbine blade.

In some embodiments the lifting apparatus may be lifted by a crane or other solutions known by the skilled person.

The longitudinal bendable structure may be any long and heavy bendable object such as an airplane wing or a roof, and it may be a curved object such as a wind turbine blade. It is thus necessary to provide a lifting apparatus that can accommodate to e.g., a curved longitudinal bendable structure.

The longitudinal beam may be positioned substantially parallel to and above the longitudinal bendable structure to be lifted by the lifting apparatus, thereby achieving a balanced and stable lift of the longitudinal bendable structure.

In some embodiments the longitudinal beam may comprise of four sections with one or more rigging elements.

The plurality of attachment units may be evenly distributed along the longitudinal beam, thereby obtaining an even distribution of vacuum grippers along the longitudinal beam. An advantage of this is that an equal grip is ensured along the entire longitudinal bendable structure.

In some embodiments, the end sections of the longitudinal beam may comprise more attachment units than the middle sections.

In some embodiments, the middle sections of the longitudinal beam may comprise more attachment units than the end sections.

In some embodiments, all sections of the longitudinal beam may comprise the same number of attachment units.

The vacuum gripper may be a suction plate or disc, that is configured for gripping a part of the longitudinal bendable structure.

The displaceable arm that is linear displaceable substantially orthogonal to the longitudinal beam in the direction of the longitudinal bendable structure, between a retracted and an extended position. Since the displaceable arm is connected to the vacuum gripper, the displacement of the displaceable arm result in the displacement of the vacuum gripper between a retracted and an extended position.

The displacement of the vacuum gripper may be a displacement to any position between the retracted and the extended position.

In the retracted position, the displaceable arm may retract the vacuum gripper towards the longitudinal beam and away from the longitudinal bendable structure

In the extended position, the displaceable arm may extend the vacuum gripper towards the longitudinal bendable structure and away from the longitudinal beam.

An advantage of this is that the position of each vacuum gripper can be adjusted to accommodate the shape of the longitudinal bendable structure such as a curved wind turbine blade, thereby supporting the original shape of the longitudinal bendable structure while lifting it.

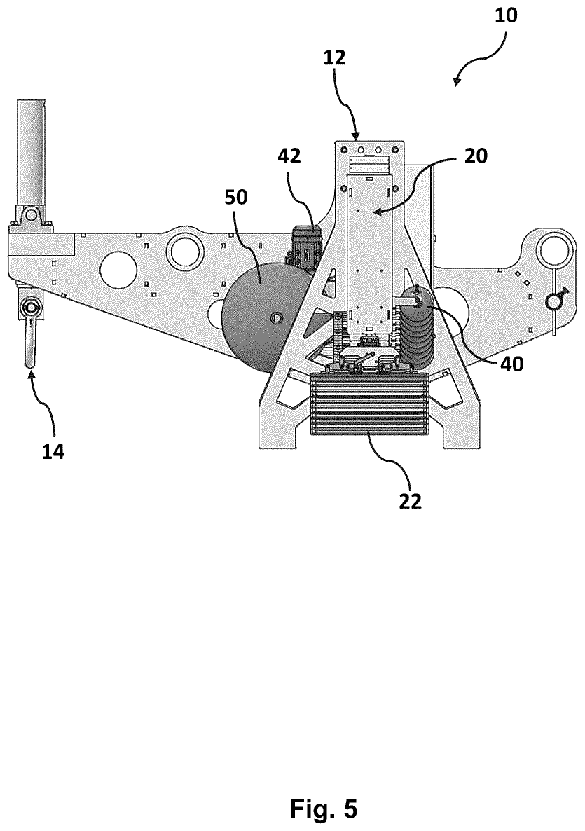

The vacuum at the vacuum grippers may be provided by one or more vacuum pumps connected to the vacuum grippers for providing suction. Each vacuum gripper may have a vacuum pump, or two or more of the vacuum grippers may have a common vacuum pump. In an embodiment shown in FIG. 5 a single vacuum pump is used for providing suction to all the vacuum grippers shown in FIG. 5.

The displaceable arm is displaced between the retracted position and the extended position by a power transmission unit. The power transmission unit may be pneumatic or hydraulic. When a hydraulic or pneumatic fluid flows into the power transmission unit, the displaceable arm may be displaced towards the extended position and when a hydraulic or pneumatic fluid flows out of the power transmission unit, the displaceable arm may be displaced toward the retracted position. Thereby adjusting the individual vacuum grippers to different displacement positions to accommodate the shape of the longitudinal bendable structure along the longitudinal beam.

The plurality of power transmission units comprised in the plurality of attachment units are in fluid communication with a global power transmission system, wherein the fluid may be inert gas, air, water, or oil. The global power transmission system may during the gripping process allow the positions of the power transmission units to be individually adjusted to the longitudinal bendable structure without affecting the other power transmission units. Thereby ensuring a strong grip with optimal contact between the vacuum grippers and the longitudinal bendable structure.

The global power transmission system may include a fluid pump for controlling the amount of fluid in the global power transmission. The fluid pump may be configured to increase or decrease the amount of fluid in the global power transmission.

The global power transmission system may during the lift create a mutual internal dependency between the power transmission units, where a bend in the longitudinal bendable structure during a lift, results in the displaceable arms in connections with the vacuum grippers located at the bend being displaced in the direction of the bend. The displacement may be caused by a change in the fluid volume of the power transmission units displacing the displaceable arms. To counteract the bending motion across the longitudinal bendable structure to prevent loss of grip by the vacuum grippers, a displacement of the rest of the displaceable arms may be provided in a direction and to a degree that counteracts the bending induced displacement. The global power transmission system thereby balances the power transmission units such that the vacuum grippers follow the bending motion of the longitudinal bendable structure and loss of grip, which may result in dropping the longitudinal bendable structure, is prevented.

In embodiments of the lifting apparatus, the power transmission units may be pneumatic or hydraulic.

In some embodiments the power transmission units may be pneumatic, where the fluid may be inert gas or air.

In some embodiments the power transmission units may be hydraulic, where the fluid may be a suitable hydraulic oil.

In embodiments of the lifting apparatus, the global power transmission system and the power transmission units may share a common fluid reservoir.

The common fluid reservoir may be in fluid communication with the global power transmission system and the power transmission units, wherein the fluid volume may be adjustable or fixed.

An adjustable fluid volume allows individual and independent displacement of the power transmission units, and a fixed fluid volume provides a mutual dependency between the power transmission units, where the displacement of one power transmission unit is balanced by the other power transmission units.

The fluid flowing to and from the common fluid reservoir may be controlled by a valve comprised in the global power transmission system. The valve is displaced between an open state, where the fluid flows to and from the common fluid reservoir, and a closed state, where the flow of fluid to and from the common fluid reservoir is blocked. The valve can be placed between the fluid pump and the common fluid reservoir or after the fluid pump and the effect will be the same. In some embodiments, the valve will be two valves in the case where the valves are positioned downstream to the fluid pump as there may be a forward flow and return flow.

Thereby the fluid volume is adjustable, when the valve is in the open state, and the fluid volume is fixed, when the valve is in the closed state.

The entire fluid system comprising of the common fluid reservoir, the global power transmission system, and the power transmission units, contain a constant total fixed fluid volume. The total fixed fluid volume is divided into a first fluid volume located between the common fluid reservoir and the valve, and a second fluid volume located between the valve and the downstream positioned power transmission units. Thus, when the valve is open, the fluid flows freely between the first and second fluid volumes, which result in the first and second fluid volumes being adjustable; and when the valve is closed, the fluid flow between the first and second fluid volumes is blocked, which result in the first and second fluid volumes being fixed.

In some embodiments, the fluid communication to each power transmission unit, may be controlled by a local fluid pump, configured for controlling the flow of fluid to and from the power transmission unit. Thus, controlling the displacement of the displaceable arm

In embodiments of the lifting apparatus, the global power transmission system may be changeable between two states:
a connection state, wherein the fluid volume in the common fluid reservoir is adjustable, thereby enabling the power transmission unit to be individually controllable; and
   a lifting state, wherein the fluid volume in the common fluid reservoir is fixed, thereby enabling self-balancing of the power transmission units by retracting and/or extending the displaceable arms

In the connection state, the fluid volume is adjustable, which allows the position of the individual vacuum grippers to be adjusted to the longitudinal bendable structure as fluid can be displaced to and from the common fluid reservoir. The position of the vacuum gripper is controlled by a fluid flowing into the power transmission unit causing the displaceable arm to extend towards the longitudinal bendable structure, or by a fluid flowing out of the power transmission structure causing the displaceable arm to retract away from the longitudinal bendable structure. As the fluid volume is adjustable, the fluid volume flowing in and out of each individual power transmission unit is independent of the fluid volume flowing in and out of the other power transmission units.

Thereby, each individual vacuum gripper may be adjusted to different displacement positions without affecting the position of the other vacuum grippers, to accommodate the shape of the longitudinal bendable structure placed substantially parallel to and beneath the longitudinal beam.

An advantage of this is that a strong grip with optimal contact between the vacuum grippers and the longitudinal bendable structure is achieved.

In the lifting state, the fluid volume is fixed, which creates a mutual internal dependency between the power transmission units. Since all power transmission units are in fluid communication with each other through the global power transmission system, the fixed common fluid reservoir volume entails that a change in the fluid volume in one power transmission unit results in a counteracting change in the fluid volume in the other power transmission units. Thus, when the longitudinal bendable structure bends during a lift, the vacuum grippers located at the bend displace in the direction of the bend. That is, if the longitudinal bendable structure bends away from the longitudinal beam, then the displaceable arms in connection with the vacuum grippers located at the bend may extend; and if the longitudinal bendable structure bends towards the longitudinal beam, then the displaceable arms in connection with the vacuum grippers located at the bend may retract. To accommodate the change in fluid volume for the power transmission units located at the bend, the other transmission units displace in a direction and to a degree that counteracts the bending induced displacement.

The global power transmission system automatically adjusts the displacement of the fluid in the power transmission units as a function of the bending of the longitudinal bendable structure. Thereby, the global power transmission system self-balances the power transmission units, such that the displaceable arms follow the bending motion of the longitudinal bendable structure.

An advantage of this is that a loss of grip by one or more of the vacuum grippers due to a bending motion of the longitudinal bendable structure is prevented. This is a great advantage, as a loss of grip may result in the longitudinal bendable structure being dropped.

An advantage of the self-balancing of the power transmission units is, that there is no need for controlling the individual power transmission units during a lift.

In embodiments of the lifting apparatus, the global power transmission system may comprise a valve downstream to the common fluid reservoir and upstream to the power transmission units. The valve is open in the connection state and valve is closed in the lifting state.

The state of the global power transmission system may be controlled by displacement of the valve comprised in the global power transmission system as the valve controls flow to and from the common fluid reservoir. In the connection state, when the valve is open, it is possible to have fluid flow to and from the common fluid reservoir, and in the lifting state, where the valve is closed, flow of fluid to and from the common fluid reservoir is blocked and the total fluid volume is constant for the power transmission units.

Thereby, the fluid volume is adjustable when the valve is in the connection state, and the fluid volume is fixed when the valve is in the lifting state.

In embodiments of the lifting apparatus, one or more of the vacuum grippers may be tiltable attached to one or more of the displaceable arms.

Thereby allowing the vacuum grippers to adjust to the surface curvature of the longitudinal bendable structure, and thus the optimal contact between the vacuum grippers and the longitudinal bendable structure is achieved, which result in a strong grip.

In embodiments of the lifting apparatus, the attachment units may comprise local vacuum reservoirs.

The local vacuum reservoir will provide a negative air pressure between the vacuum gripper and the surface of the longitudinal bendable structure, thereby adhering the vacuum gripper to the surface of the longitudinal bendable structure. The local vacuum reservoir will also ensure that suction is provided even if there is a power loss, and the one or more vacuum pumps are no longer able to provide suction then the grip is not lost immediately. Furthermore, there is no requirements for the one or more vacuum pumps to run continuously as the local vacuum reservoir will act as a buffer.

In some embodiments, each attachment unit may comprise a vacuum pump, thereby providing an active vacuum at each vacuum gripper.

In some embodiments, one common vacuum pump may be connected to one or more common vacuum reservoirs having a volume 5 times or 10 times or 25 times larger than a single local vacuum reservoir. The one or more common vacuum reservoirs are fluidly connected to the local vacuum reservoirs. The one or more vacuum pumps then pump the one or more common vacuum reservoirs for creating a vacuum in the one or more common vacuum reservoirs which then provide a suction of one or more local vacuum reservoirs which in turn provide suction for the vacuum gripper. Thereby a negative air pressure between the vacuum grippers and the surface of the longitudinal bendable structure is ensured which causes a strong continuous adhesion during the lift.

In some embodiments the lifting apparatus may comprise two common vacuum reservoirs.

An advantage of having one common vacuum pump is that it is energy efficient and provides an even and constant vacuum between the vacuum gripper and the surface of the longitudinal bendable structure.

An advantage of the local and common vacuum reservoirs is that if the power to the vacuum pump fails, the vacuum stored in the vacuum reservoirs maintains the negative air pressure between the vacuum grippers and the surface of the longitudinal bendable structure. Thereby preventing the longitudinal bendable structure from being dropped during short power shortages.

In embodiments of the lifting apparatus, the longitudinal beam may comprise a beam length in a range of 5 in to 150 m or 10 in to 125 m or 25 to 100 m such as 40 m or 60 m.

In some embodiments the beam length may be substantially equal to or longer than the length of the longitudinal bendable structure.

An aspect of embodiments of the invention is achieved by a method for lifting a longitudinal bendable structure such as a wind turbine blade. In embodiments, the method comprises steps of
providing a lifting apparatus;
positioning the lifting apparatus along the longitudinal bendable structure;
displacing the displaceable arms using the power transmission units such that the vacuum grippers engage the surface of the longitudinal bendable structure;
lifting the longitudinal bendable structure while balancing the power transmission units using the global power transmission system.

The longitudinal bendable structure may be any long and heavy bendable object such as an airplane wing or a roof, and it may be a curved object such as a wind turbine blade. It is thus necessary to provide a method for lifting a longitudinal bendable structure that can accommodate to e.g., a curved longitudinal bendable structure.

The step of providing may be a step of providing a lifting apparatus for lifting a longitudinal bendable structure such as a wind turbine blade, where a part of or the entire wind turbine blade may be lifted.

The step of positioning may be a step of positioning the longitudinal beam of the lifting apparatus substantially parallel to and above the longitudinal bendable structure to be lifted by embodiments of the method, thereby achieving a balanced and stable lift of the longitudinal bendable structure.

The step of displacing may be a step of linearly displacing the displaceable arm substantially orthogonal to the longitudinal beam in the direction of the longitudinal bendable structure, between a retracted and an extended position. Displacing the displaceable arm connected to a vacuum gripper result in the displacement of the vacuum gripper between the retracted and extended position. The vacuum gripper may be displaced to any position between the retracted and the extended position.

An advantage of this is that the position of each vacuum gripper can be adjusted to accommodate the shape of the longitudinal bendable structure such as a curved wind turbine blade, thereby supporting the original shape of the longitudinal bendable structure while lifting it.

A power transmission unit displaces the displaceable arm between the retracted position and the extended position. The power transmission unit may be pneumatic or hydraulic, that displaces the displaceable arm towards the extended position, when a hydraulic or pneumatic fluid flows into the power transmission unit, and towards the retracted position when a hydraulic or pneumatic fluid flows out of the power transmission unit. Thereby adjusting the individual vacuum grippers to different displacement positions to engage the surface of the longitudinal bendable structure.

The step of displacing may further be a step of displacing the individual displaceable arms in connection with the vacuum grippers independently of each other.

An advantage of this is that each vacuum gripper can be adjusted to accommodate the shape of the longitudinal bendable structure along the longitudinal beam, and an optimal contact between the vacuum gripper and the longitudinal bendable structure is achieved, which results in a strong grip.

The power transmission units are in fluid communication with a global power transmission system. During the step of lifting, the global power transmission system may create a mutual internal dependency between the power transmission units, where a bend in the longitudinal bendable structure during a lift, results in the displaceable arms in connections with the vacuum grippers located at the bend are displaced in the direction of the bend. The displacement may be caused by a change in the fluid volume of the power transmission units displacing the displaceable arms. To counteract the bending motion across the longitudinal bendable structure to prevent loss of grip by the vacuum grippers, a displacement of the rest of displaceable arms may be provided in a direction and to a degree that counteracts the bending induced displacement. The global power transmission system thereby balances the power transmission units, such that the vacuum grippers follow the bending motion of the longitudinal bendable structure and loss of grip, which may result in dropping the longitudinal bendable structure, is prevented.

In an aspect of embodiments of the method, the step of displacing may be performed while the global power transmission system is in the connection state and the step of lifting may be performed while the global power transmission system is in the lifting state.

During the step of displacing the global power transmission system may be in the connection state, where a fluid volume is adjustable. The adjustable fluid volume allows the fluid volume flowing in and out of each individual power transmission unit to be independent of the fluid volume flowing in and out of the other power transmission units. Thereby, each individual vacuum gripper may be adjusted to different displacement positions between the retracted and extended positions without affecting the position of the other vacuum grippers. Thereby accommodating the position of the vacuum grippers to the shape of the longitudinal bendable structure placed substantially parallel to and beneath the longitudinal beam.

An advantage of this is that a strong grip with optimal contact between the vacuum grippers and the longitudinal bendable structure is achieved.

During the step of lifting the global power transmission system may be in the lifting state, where a fluid volume is fixed. The fixed the fluid volume may create a mutual internal dependency between the power transmission units, since all power transmission units are in fluid communication with each other through the global power transmission system. A change in the fluid volume in one power transmission unit may result in a counteracting change in the fluid volume in the other power transmission units. Thus, when the longitudinal bendable structure bends during a lift, the vacuum grippers located at the bend displace in the direction of the bend, and to accommodate the change in fluid volume for these power transmission units, the other transmission units may displace in a direction and to a degree that counteracts the bending induced displacement.

Thus, during the step of lifting, the global power transmission system automatically adjusts the displacement of the fluid in the power transmission units as a function of the bending of the longitudinal bendable structure. Thereby, the global power transmission system self-balances the power transmission units such that the displaceable arms follow the bending motion of the longitudinal bendable structure.

An advantage of this is that a loss of grip by one or more of the vacuum grippers due to a bending motion of the longitudinal bendable structure during the step of lifting is prevented. This is a great advantage, as a loss of grip may result in the longitudinal bendable structure being dropped.

### BRIEF DESCRIPTION

Some of the embodiments will be described in detail, with references to the following Figures, wherein like designations denote like members, wherein:

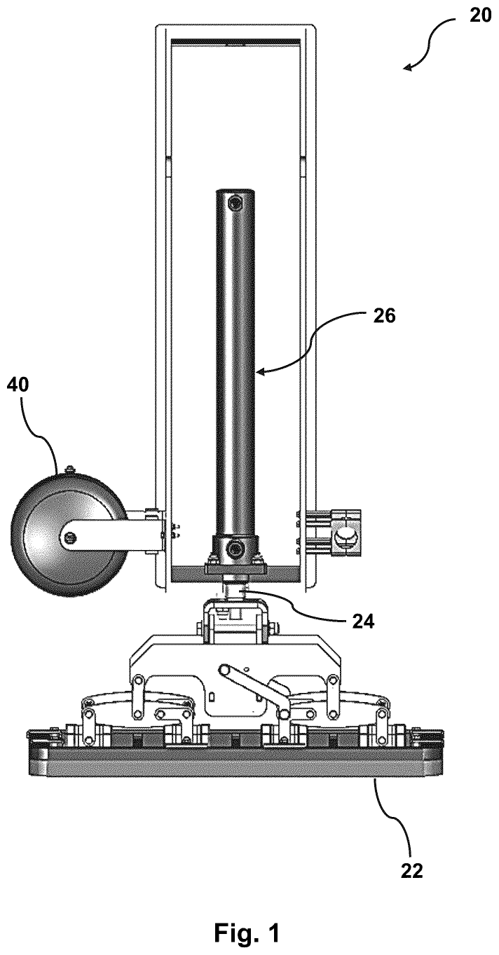

FIG. 1 illustrates an attachment unit;

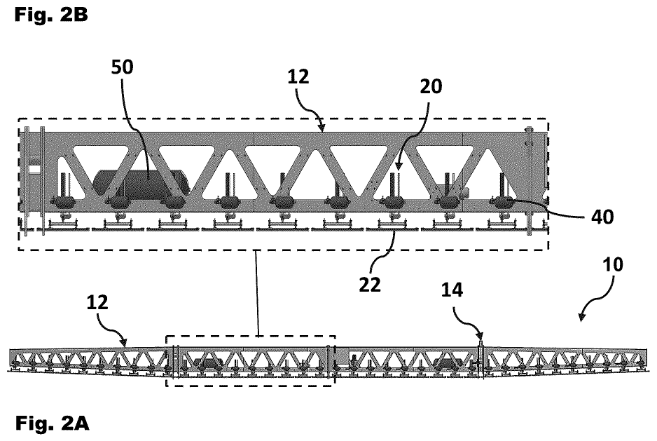

FIG. 2A illustrates a front view of a lifting apparatus for lifting a longitudinal bendable structure with an enlarged section;

FIG. 2B is an exploded view of FIG. 2A;

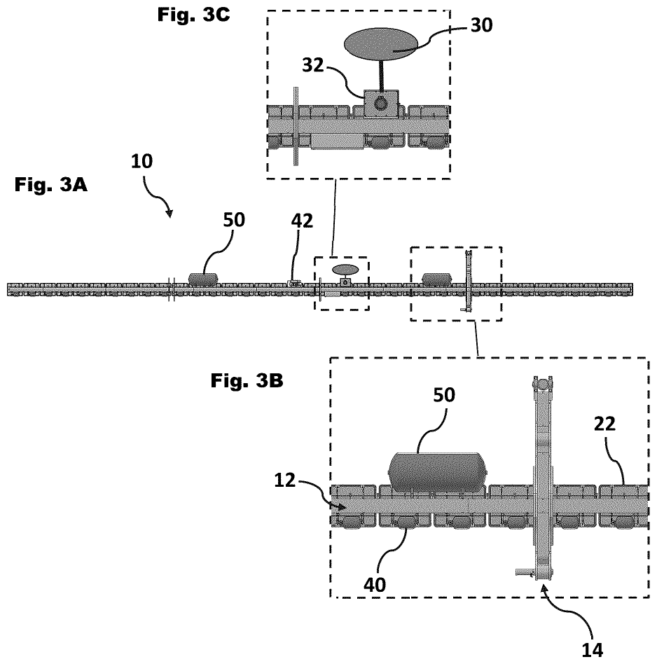

FIG. 3A illustrates a top view of a lifting apparatus for lifting a longitudinal bendable structure with an enlarged section;

FIG. 3B is an exploded view of FIG. 3A;

FIG. 3C is an exploded view of FIG. 3A;

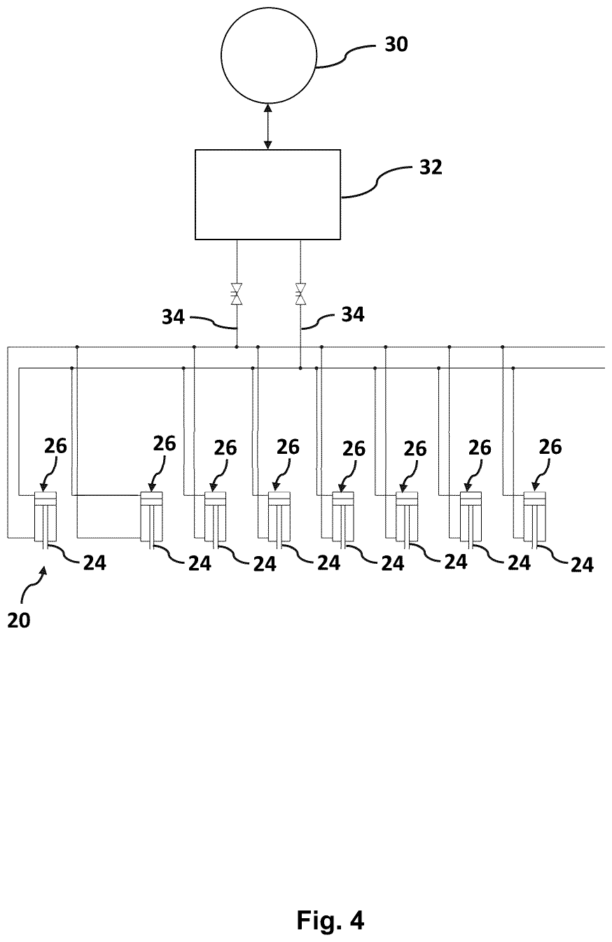

FIG. 4 illustrates the fluid communication between the common fluid reservoir, the global power transmission system and the power transmission units;

FIG. 5 illustrates a side view of a lifting apparatus for lifting a longitudinal bendable structure;

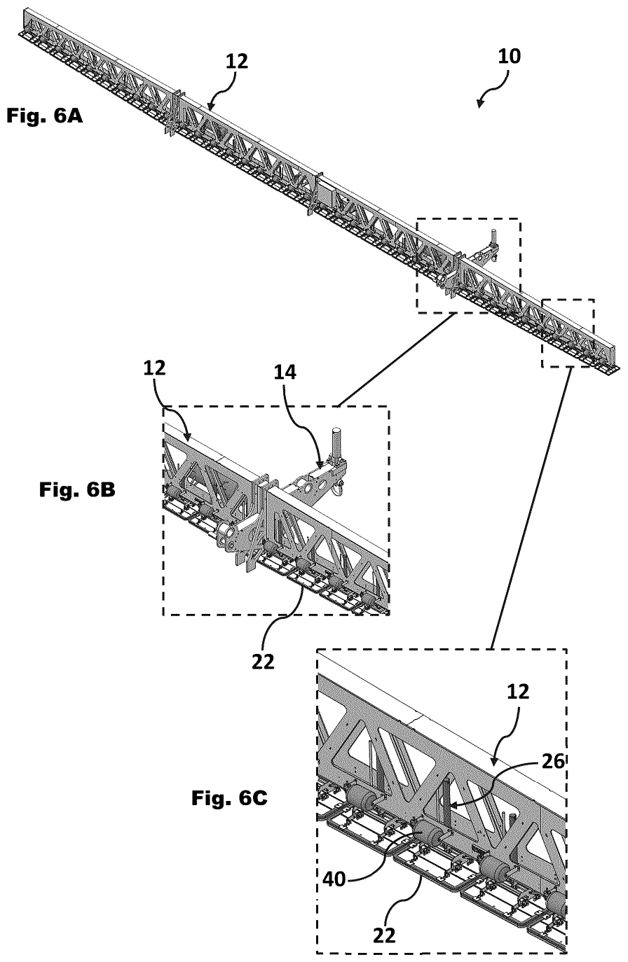

FIG. 6A illustrates a front perspective view of a lifting apparatus for lifting a longitudinal bendable structure with two enlarged sections;

FIG. 6B is an exploded view of FIG. 6A;

FIG. 6C is an exploded view of FIG. 6A; and

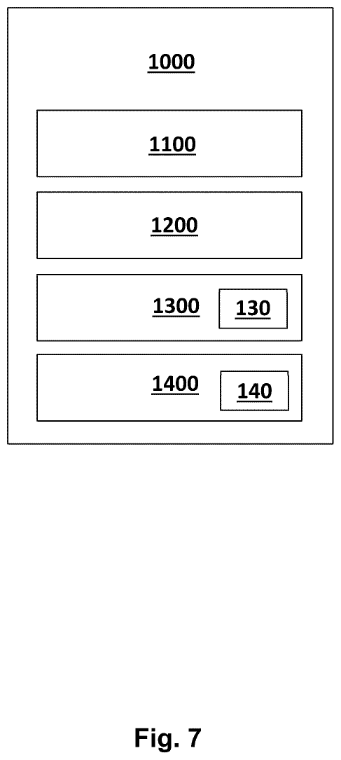

FIG. 7 illustrates a method for lifting a longitudinal bendable structure.

### LIST OF REFERENCE NUMERALS

| | |
|---|---|
| Lifting apparatus | 10 |
| Longitudinal beam | 12 |
| Rigging elements | 14 |
| Attachment units | 20 |
| Vacuum gripper | 22 |
| Displaceable arm | 24 |
| Power transmission unit | 26 |
| Common fluid reservoir | 30 |
| Fluid pump | 32 |
| Valve | 34 |
| Local vacuum reservoir | 40 |
| Vacuum pump | 42 |
| Common vacuum reservoir | 50 |
| Connection state | 130 |
| Lifting state | 140 |
| Method | 1000 |
| Providing | 1100 |
| Positioning | 1200 |
| Displacing | 1300 |
| Lifting | 1400 |

### DETAILED DESCRIPTION

FIG. 1 illustrates an attachment unit 20, where a vacuum gripper 22 is configured for gripping a part of a longitudinal bendable structure. The vacuum gripper 22 is connected to a displaceable arm 24, that is linear displaceable substantially orthogonal to the longitudinal beam 12 (FIGS. 2A-5) in the direction of the longitudinal bendable structure, between a retracted and an extended position. Thus, the displacement of the displaceable arm 24 results in the displacement of the vacuum gripper 22 between a retracted and an extended position. The displacement of the vacuum gripper 22 may be a displacement to any position between the retracted and extended positions.

In the retracted position, the displaceable arm 24 may retract the vacuum gripper 22 towards the longitudinal beam 12 and away from the longitudinal bendable structure.

In the extended position, the displaceable arm 24 may extend the vacuum gripper 22 towards the longitudinal bendable structure and away from the longitudinal beam 12.

Thereby, the position the vacuum gripper 22 may be adjusted to accommodate the shape of the longitudinal bendable structure such as a curved wind turbine blade.

The vacuum gripper 22 may further be tiltable attached to the displaceable arm 24. This allows the vacuum gripper 22 to adjust to the surface curvature of the longitudinal bendable structure, thereby achieving the optimal engagement between the vacuum gripper 22 and the longitudinal bendable structure.

The vacuum gripper 22 may be a suction plate or disc, that is configured for gripping a part of the longitudinal bendable structure.

The displaceable arm 24 is displaced between the retracted position and the extended position by a power transmission unit 26. The power transmission unit 26 may be pneumatic or hydraulic. When a hydraulic or pneumatic fluid flows into the power transmission unit 26, the displaceable arm 24 may be displaced towards the extended position and when a hydraulic or pneumatic fluid flows out of the power transmission unit 26, the displaceable arm 24 may be displaced toward the retracted position. Thereby, the position of the vacuum gripper 22 can be adjusted to accommodate the shape of a specific part of the longitudinal bendable structure.

In some embodiments the power transmission unit 26 may be pneumatic, where the fluid may be inert gas or air.

In some embodiments the power transmission unit 26 may be hydraulic, where the fluid may be a suitable hydraulic oil.

A vacuum at the vacuum gripper 22 may be provided by a vacuum pump 42 (not shown) connected to the vacuum gripper 22 for providing suction. The vacuum pump 42 may be connected to a local vacuum reservoir 40 providing a negative air pressure between the vacuum gripper 22 and the surface of the longitudinal bendable structure, thereby adhering the vacuum gripper 22 to the surface of the longitudinal bendable structure. The local vacuum reservoir 40 will also ensure that suction is provided even if there is a power loss, and the vacuum pump 42 is no longer able to provide suction then the grip is not lost immediately. Furthermore, there is no requirements for the vacuum pump 42 to run continuously as the local vacuum reservoir 40 will act as a buffer.

FIG. 2A illustrates a front view of a lifting apparatus 10 for lifting a longitudinal bendable structure such as a wind turbine blade, and FIG. 2B is an enlarged section of a part of the lifting apparatus 10.

The longitudinal bendable structure (not shown) may be any long and heavy bendable object such as an airplane wing or a roof, and it may be a curved object such as a wind turbine blade.

The lifting apparatus 10 comprises a longitudinal beam 12 comprising one or more sections and one or more rigging elements 14, where the longitudinal beam 12 may be positioned substantially parallel to and above the longitudinal bendable structure to be lifted by the lifting apparatus 10, thereby achieving a balanced and stable lift of the longitudinal bendable structure.

In some embodiments the longitudinal beam 12 may comprise four sections with one or more rigging elements 14.

The longitudinal beam 12 may comprise a beam length in a range of 5 m to 150 m or 10 m to 125 m or 25 to 100 m such as 40 m or 60 m. In some embodiments the beam length may be substantially equal to or longer than the length of the longitudinal bendable structure.

A plurality of attachment units 20 (FIG. 1) may be evenly distributed along the longitudinal beam 12, thereby obtaining an even distribution of vacuum grippers 22 along the longitudinal beam 12.

In some embodiments, the end sections of the longitudinal beam 12 may comprise more attachment units 20 than the middle sections.

In some embodiments, the middle sections of the longitudinal beam 12 may comprise more attachment units 20 than the end sections.

In some embodiments, all sections of the longitudinal beam 12 may comprise the same number of attachment units 20.

The vacuum at the vacuum grippers 22 may be provided by one or more vacuum pumps 42 (FIGS. 3A and 5) connected to the vacuum grippers 22 for providing suction. Each vacuum gripper 22 may have a vacuum pump 42, or two or more of the vacuum grippers 22 may have a common vacuum pump 42. In an embodiment shown in FIG. 5, a single vacuum pump 42 is used for providing suction to all the vacuum grippers 22 shown in FIG. 5.

The one or more vacuum pumps 42 may be connected to local vacuum reservoirs 40 providing a negative air pressure between the vacuum grippers 22 and the surface of the longitudinal bendable structure, thereby adhering the vacuum grippers 22 to the surface of the longitudinal bendable structure. The local vacuum reservoirs 40 will also ensure that suction is provided even if there is a power loss, and the one or more vacuum pumps 42 are no longer able to provide suction then the grip is not lost immediately. Further-more, there is no requirements for the one or more vacuum pumps 42 to run continuously as the local vacuum reservoirs 40 will act as a buffer.

In some embodiments, each attachment unit 20 may comprise a vacuum pump 42, thereby providing an active vacuum at each vacuum gripper 22.

In some embodiments, one common vacuum pump 42 may be connected to one or more common vacuum reservoirs 50 having a volume 5 times or 10 times or 25 times larger than a single local vacuum reservoir 40. The one or more common vacuum reservoirs 50 are fluidly connected to the local vacuum reservoirs 40. The one or more vacuum pumps 42 then pump the one or more common vacuum reservoirs 50 for creating a vacuum in the one or more common vacuum reservoirs 50 which then provide a suction of one or more local vacuum reservoirs 40 which in turn provide suction for the vacuum grippers 22. Thereby, a negative air pressure between the vacuum grippers 22 and the surface of the longitudinal bendable structure is ensured, which causes a strong continuous adhesion during the lift.

Thus, if the power to the vacuum pump 42 fails, the vacuum stored in the vacuum reservoirs 40, 50 maintains the negative air pressure between the vacuum grippers 22 and the surface of the longitudinal bendable structure. Thereby preventing the longitudinal bendable structure from being dropped during short power shortages.

In some embodiments the lifting apparatus 10 may comprise two common vacuum reservoirs 50.

The plurality of attachment units 20 comprise a plurality of power transmission units 26, which are in fluid communication with a global power transmission system, wherein the fluid may be inert gas, air, water, or oil.

The global power transmission system may include a fluid pump 32 for controlling the amount of fluid in the global power transmission. The fluid pump 32 may be configured to increase or decrease the amount of fluid in the global power transmission.

The global power transmission system and the power transmission units 26 may be in fluid communication with a common fluid reservoir 30, where the fluid volume may be adjustable or fixed. An adjustable fluid volume allows individual and independent displacement of the power transmission units 26, and a fixed fluid volume provides a mutual dependency between the power transmission units 26, where the displacement of one power transmission unit 26 is balanced by the other power transmission units 26.

The fluid flowing to and from the common fluid reservoir 30 may be controlled by a valve 34 comprised in the global power transmission system. The valve 34 is displaced between an open state, where the fluid flow to and from the common fluid reservoir 30, and a closed state, where the flow of fluid to and from the common fluid reservoir 30 is blocked. The valve 34 can be placed between the fluid pump 32 and the common fluid reservoir 30 or after the fluid pump 32 and the effect will be the same. In some embodiments, the valve 34 will be two valves 34 in the case where the valves 34 are positioned downstream to the fluid pump 32 as there may be a forward flow and return flow.

Thereby, the fluid volume is adjustable, when the valve is in the open state, and the fluid volume is fixed, when the valve is in the closed state.

The entire fluid system comprising the common fluid reservoir 30, the global power transmission system, and the power transmission units 26, contain a constant total fixed fluid volume. The total fixed fluid volume is divided into a first fluid volume located between the common fluid reservoir 30 and the valve 34, and a second fluid volume located between the valve 34 and the downstream positioned power transmission units 26. Thus, when the valve 34 is open, the fluid flows freely between the first and second fluid volumes, which result in the first and second fluid volumes being adjustable; and when the valve 34 is closed, the fluid flow between the first and second fluid volumes is blocked, which result in the first and second fluid volumes being fixed.

The global power transmission system may be changeable between two states. A connection state 130, where the fluid volume is adjustable, and lifting state 140, wherein the fluid volume is fixed.

In the connection state 130, the fluid volume is adjustable, which allows the position of the individual vacuum grippers 22 to be adjusted to the longitudinal bendable structure. The position of the vacuum gripper 22 is controlled by a fluid flowing into the power transmission unit 26 causing the displaceable arm 24 to extend towards the longitudinal bendable structure, or by a fluid flowing out of the power transmission unit 26 causing the displaceable arm 24 to retract away from the longitudinal bendable structure. As the fluid volume is adjustable the fluid volume flowing in and out of each individual power transmission unit 26 is independent of the fluid volume flowing in and out of the other power transmission units 26. Each individual vacuum gripper 22 can, thus, be adjusted to different displacement positions without affecting the position of the other vacuum grippers 22.

In the lifting state 140, the fluid volume is fixed, which creates a mutual internal dependency between the power transmission units 26, since all power transmission units 26 are in fluid communication with each other through the global power transmission system. The fixed fluid volume entails that a change in the fluid volume in one power transmission unit 26 results in a counteracting change in the fluid volume in the other power transmission units 26.

When the longitudinal bendable structure bends during a lift, the vacuum grippers 22 located at the bend, displace in the direction of the bend. That is, if the longitudinal bendable structure bends away from the longitudinal beam 12, then the displaceable arm 24 in connection with the vacuum grippers 22 located at the bend will extend; and if the longitudinal bendable structure bends towards the longitudinal beam 12, then the displaceable arm 24 in connection with the vacuum grippers 22 located at the bend will retract. The displacement causes a change in the fluid volume for the power transmission units 26 located at the bend, this volume change induces a displacement of the other power transmission units 26 in a direction and to a degree that counteracts the bending induced displacement.

In the lifting state 140, the global power transmission system automatically adjusts the displacement of the fluid in the power transmission units 26 as a function of the bending of the longitudinal bendable structure. Thereby, the global power transmission system self-balances the power transmission units 26 such that the displaceable arms 24 follow the bending motion of the longitudinal bendable structure.

The state of the global power transmission system may be controlled by displacement of a valve 34 comprised in the global power transmission system as the valve 34 controls flow to and from the common fluid reservoir 30 (FIG. 4). In the connection state 130, when the valve 34 is open, it is possible to have fluid flow to and from the common fluid reservoir 30, and in the lifting state 140, where the valve 34 is closed, then flow of fluid to and from the common fluid reservoir 30 is blocked and the total fluid volume is constant for the power transmission units 26.

Thereby the fluid volume is adjustable, when the valve 34 is in the connection state 130, and the fluid reservoir is fixed, when the valve 34 is in the lifting state 140.

FIG. 3A illustrates a top view of a lifting apparatus 10 for lifting a longitudinal bendable structure such as a wind turbine blade, and FIG. 2B is an enlarged section of a part of the lifting apparatus 10, as illustrated and described for FIG. 2A.

FIG. 3C is an enlarged section of a part of the lifting apparatus 10 that may comprise the fluid pump 32 in connection with the common fluid reservoir 30. The fluid flowing to and from the common fluid reservoir 30 may be controlled by displacing a valve 34 (FIG. 4) comprised in the global power transmission system. The valve 34 is displaced between a connection state 130 and a lifting state 140.

The valve 34 may be in the connection state 130, where the valve 34 is open and the fluid flow to and from the common fluid reservoir 30, and the lifting state 140, where the valve 34 is closed and the flow of fluid to and from the common fluid reservoir 30 is blocked.

Thereby the fluid volume is adjustable, when the valve 34 is in the connection state 130, and the fluid volume is fixed, when the valve 34 is in the lifting state 140.

FIG. 4 illustrates the fluid communication between the common fluid reservoir 30, the global power transmission system and the power transmission units 26.

The entire fluid system comprising of the common fluid reservoir 30, the global power transmission system, and the power transmission units 26, contain a constant total fixed fluid volume. The total fixed fluid volume is divided into a first fluid volume located between the common fluid reservoir 30 and the valve 34, and a second fluid volume located between the valve 34 and the downstream positioned power transmission units 26. Thus, when the valve 34 is open, the fluid flows freely between the first and second fluid volumes, which result in the first and second fluid volumes being adjustable; and when the valve 34 is closed, the fluid flow between the first and second fluid volumes is blocked, which result in the first and second fluid volumes being fixed.

The common fluid reservoir 30 may be in fluid communication with the global power transmission system and the power transmission units 26, where the fluid volume may be adjustable or fixed. The fluid flowing to and from the common fluid reservoir 30 may be controlled by displacing a valve 34 comprised in the global power transmission system. The valve 34 may be displaced between a connection state 130, where the valve 34 is open and the fluid flow to and from the common fluid reservoir 30, and a lifting state 140, where the valve 34 is closed and the flow of fluid to and from the common fluid reservoir 30 is blocked. The valve 34 can be placed between the fluid pump 32 and the common fluid reservoir 30 or after the fluid pump 32 and the effect will be the same. In some embodiments, the valve 34 will be two valves 34 in the case where the valves 34 are positioned downstream to the fluid pump 32 as there may be a forward flow and return flow.

Thereby the fluid volume is adjustable, when the valve 34 is in the connection state 130, and the fluid volume is fixed, when the valve 34 is in the lifting state 140.

In some embodiments, the fluid communication to each power transmission unit 26, may be controlled by a local fluid pump, configured for controlling the flow of fluid to and from the power transmission unit 26. Thus, controlling the displacement of the displaceable arm 24.

In the connection state 130, the valve 34 may be open and the fluid volume may be adjustable. This allows fluid to flow to and from the global power transmission system and the power transmission units 26, where a fluid flowing into the power transmission units 26 causes the displaceable arms 24 to extend towards the longitudinal bendable structure, or where a fluid flowing out of the power transmission units 26 causes the displaceable arms 24 to retract away from the longitudinal bendable structure.

As the fluid volume is adjustable the fluid volume flowing in and out of each individual power transmission unit 26 is independent of the fluid volume flowing in and out of the other power transmission units 26.

In the lifting state 140, the valve 34 may be closed and the fluid volume may be fixed. This creates a mutual internal dependency between the power transmission units 26, since all the power transmission units 26 are in fluid communication with each other through the global power transmission system. The fixed fluid volume entails that a change in the fluid volume in one power transmission unit 26 results in a counteracting change in the fluid volume in the other power transmission units 26. Thus, when the longitudinal bendable structure bends during a lift, the displaceable arms 24 located at the bend displace in the direction of the bend. That is, if the longitudinal bendable structure bends away from the longitudinal beam 12, then the displaceable arms 24 located at the bend may extend; and if the longitudinal bendable structure bends towards the longitudinal beam 12, then the displaceable arms 24 located at the bend may retract. To accommodate the change in fluid volume for the power transmission units 26 located at the bend, a corresponding fluid volume may flow into or out of the other power transmission units 26 displacing them in a direction and to a degree that counteracts the bending induced displacement.

FIGS. 5-6C illustrate different perspective views of the lifting apparatus 10 for lifting a longitudinal bendable structure such as a wind turbine blade as illustrated and described for FIGS. 2A-3B.

FIG. 6 illustrates a method 1000 for lifting a longitudinal bendable structure such as a wind turbine blade. In embodiments, the method 1000 comprises a step of providing 1100 a lifting apparatus 10 (FIGS. 1-5). The lifting apparatus 10 is positioned along a longitudinal bendable structure during a step of positioning 1200, where the longitudinal beam 12 of the lifting apparatus 10 is positioned substantially parallel to and above the longitudinal bendable structure.

The step of positioning 1200 is followed by a step of displacing 1300, where the displaceable arms 24 are displaced linearly and substantially orthogonal to the longitudinal beam 12 in the direction of the longitudinal bendable structure, between a retracted and an extended position. Displacing the displaceable arms 24 connected to a vacuum gripper 22 results in the displacement of the vacuum gripper 22 between the retracted and extended position.

The vacuum grippers 22 may be displaced to any position between the retracted and the extended position.

The displaceable arms 24 are displaced by the power transmission units 26, that may be pneumatic or hydraulic. The power transmission units 26 displace the displaceable arms 24 towards the extended position, when a hydraulic or pneumatic fluid flows into the power transmission units 26, and towards the retracted position when a hydraulic or pneumatic fluid flows out of the power transmission units 26.

The step of displacing 1300 may be a step of displacing 1300 the individual displaceable arms 24 in connection with the vacuum grippers 22 independently of each other.

During the step of displacing 1300 the global power transmission system may be in the connection state 130, where a common fluid reservoir 30 volume is adjustable. The adjustable common fluid reservoir 30 volume allows the fluid volume flowing in and out of each individual power transmission units 26 to be independent of the fluid volume flowing in and out of the other power transmission units 26. Thereby, each individual vacuum gripper 22 may be adjusted to different displacement positions between the retracted and extended positions, without affecting the position of the other vacuum grippers 22. The step of displacing 1300 may adjust the vacuum grippers 22 to accommodate the shape of and engage with the surface of the longitudinal bendable structure placed substantially parallel to and beneath the longitudinal beam 12.

In embodiments, the method 1000 further comprises a step of lifting 1400, where the lifting apparatus 10 lifts the longitudinal bendable structure. The global power transmission system may create a mutual internal dependency between the power transmission units 26 during the step of lifting 1400, where a bend in the longitudinal bendable structure during a lift, results in the displaceable arms 24 in connection with the vacuum grippers 22 located at the bend being displaced in the direction of the bend. The displacement may be caused by a change in the fluid volume of the power transmission units 26 displacing the displaceable arm. To counteract the bending motion across the longitudinal bendable structure to prevent loss of grip by the vacuum grippers 22, a displacement of the rest of displaceable arms 24 may be provided in a direction and to a degree that counteracts the bending induced displacement. The global power transmission system thereby balances the power transmission units 26 such that the vacuum grippers 22 follow the bending motion of the longitudinal bendable structure.

During the step of lifting 1400 the global power transmission system may be in the lifting state 140, where a common fluid reservoir 30 volume is fixed. The fixed common fluid reservoir 30 volume may create a mutual internal dependency between the power transmission units 26, since all power transmission units 26 are in fluid communication with each other through the global power transmission system.

A change in the fluid volume in one power transmission unit 26 may result in a counteracting change in the fluid volume in the other power transmission units 26. Thus, when the longitudinal bendable structure bends during a lift, the vacuum grippers 22 located at the bend displace in the direction of the bend. To accommodate the change in fluid volume for these power transmission units 26, the other transmission units 26 may displace in a direction and to a degree that counteracts the bending induced displacement. Thus, during the step of lifting 1400, the global power transmission system automatically adjusts the displacement of the fluid in the power transmission units 26 as a function of the bending of the longitudinal bendable structure. Thereby, the global power transmission system self-balances the power transmission units 26 such that the displaceable arms 24 follow the bending motion of the longitudinal bendable structure.

Although the present invention has been disclosed in the form of embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements. The mention of a “unit” or a “module” does not preclude the use of more than one unit or module.

1. A lifting apparatus for lifting a longitudinal bendable structure such as a wind turbine blade, the lifting apparatus comprises;
a longitudinal beam comprising one or more sections and one or more rigging elements;
a plurality of attachment units positioned along the longitudinal beam; the attachment units include
a vacuum gripper for gripping a part of the longitudinal structure;
a displaceable arm connected to the vacuum gripper, the displaceable arm being linear displaceable between a retracted position and an extended position;
a power transmission unit configured to displacing the displaceable arm between the retracted position and the extended position; and
a global power transmission system in fluid communication with the power transmission units, the global power transmission system being configured for balancing the power transmission units.

2. The lifting apparatus according to claim 1, wherein the power transmission unit is pneumatic or hydraulic.

3. The lifting apparatus according to claim 1, wherein the global power transmission system and the power transmission units share a common fluid reservoir.

4. The lifting apparatus according to claim 3, wherein the global power transmission system being changeable between two states:
a connection state, wherein the fluid volume in the common fluid reservoir is adjustable, thereby enabling the power transmission unit to be individually controllable; and
a lifting state, wherein the fluid volume in the common fluid reservoir is fixed, thereby enabling self-balancing of the power transmission units by retracting and/or extending the displaceable arms.

5. The lifting apparatus according to claim 4, wherein the global power transmission system comprises a valve downstream to the common fluid reservoir and upstream to the power transmission units, wherein the valve is open in the connection state and closed in the lifting state.

6. The lifting apparatus according to claim 1, wherein one or more of the vacuum grippers being tiltable attached to one or more of the displaceable arms.

7. The lifting apparatus according to claim 1, wherein the attachment units comprise local vacuum reservoirs.

8. The lifting apparatus according to claim 1, wherein the longitudinal beam comprises a beam length in a range of 5 m to 150 m or 10 in to 125 m or 25 to 100 m such as 40 m or 60 m.

9. A method for lifting a longitudinal bendable structure such as a wind turbine blade, the method comprising
providing a lifting apparatus according claim 1;
positioning the lifting apparatus along a longitudinal bendable structure;
displacing the displaceable arms using the power transmission units such that the vacuum grippers engage the surface of the longitudinal bendable structure;
lifting the longitudinal bendable structure while balancing the power transmission units using the global power transmission system.

10. The method according to claim 9, wherein the step of displacing is performed while the global power transmission system is in the connection state and the step of lifting is performed while the global power transmission system is in the lifting state.
